(19) United States
(12) Patent Application Publication
(10) Pub. No.: US 2003/0190507 A1
(43) Pub. Date: Oct. 9, 2003

(54) Fuel cell and method for cold-starting such a fuel cell

(75) Inventors: Andreas Docter, Esslingen (DE); Georg Frank, Tuebingen (DE); Gerhard Konrad, Ulm (DE); Arnold Lamm, Elchingen (DE); Jens Thomas Mueller, Muenchen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/393,678

(22) Filed: Mar. 21, 2003

(30) Foreign Application Priority Data
Mar. 23, 2002 (DE) 102 13 134.1

(51) Int. Cl. H01M 8/06; H01M 8/04

(52) U.S. Cl. 429/20; 429/26; 429/17

(57) ABSTRACT

A fuel cell includes an electrolyte electrode assembly having a cathode disposed on a first side and an anode disposed on a second side of the electrolyte electrode assembly, a first flow module disposed adjacent the cathode, and a second flow module disposed adjacent the anode. At least one of the first and second flow modules includes a material suitable for exothermal hydride formation. In addition, a method for cold-starting a such fuel cell that includes flooding at least one of the first and second flow modules with a hydrogen-containing gas so as to induce the exothermic hydride formation and release heat; and heating the fuel cell using the heat.

Priority is claimed to German Patent Application No. DE 102 13 134.1, filed on Mar. 23, 2002, which is incorporated by reference herein.

### BACKGROUND

The present invention relates to a fuel cell having an electrolyte electrode assembly, on one side of which the cathode and on the other side of which the anode of the fuel cell are arranged, and having flow modules for the process gases and the coolant of the fuel cell arranged above these two electrodes.

The present invention also relates to a method for cold-starting such a fuel cell.

In PEM (Proton Membrane Exchange) fuel cells, which are known in practice, the electrolyte used is an ion exchange membrane. The ion exchange membrane comprises a sulfonated chemical compound which binds water in the membrane in order to ensure sufficient proton conductivity. On account of the freezing of the water stored in the membrane, the membrane resistance suddenly jumps by two to three powers of ten at a temperature below 0° C. Even in the case of low-temperature and medium-temperature fuel cells, such as for example the PAFC (phosphoric acid fuel cell), the resistance of the electrolyte rises by a multiple at low temperatures. In addition to the electrochemical properties of the electrolyte, the activities of the cathode and anode catalysts of a fuel cell are generally also temperature-dependent. A further factor in PEM fuel cells which are operated with reformate is that in the cold-starting phase reformate has very high carbon monoxide (CO) concentrations, and the CO tolerance of the still cold fuel cell is extremely low.

Overall, therefore, the fuel cells which are known in practice can only produce current at above a defined starting temperature, which is currently approx. 5° C. In the event of a cold start, therefore, a fuel cell must first be heated to temperatures which are above the starting temperature. On account of the considerable thermal mass of the fuel cells, this requires a considerable heating power, in particular if the cold start is to take place within similarly short times to those achieved in conventional internal combustion engines. Heating of the electrolyte electrode assembly independently of the flow modules is not possible in this case, since the heat conduction between the electrolyte electrode assembly and the flow modules have to be very good for design reasons, in order for the waste heat which is formed at the electrolyte electrode assembly when the fuel cell is operating to be dissipated to the environment.

The following example is intended to illustrate the order of magnitude of the heating power which has to be supplied.

A fuel cell stack, i.e. a fuel cell unit comprising a plurality of fuel cells connected to one another, as used for example for an automotive drive, is supposed to produce a maximum power of 60 kWel. The mass of the fuel cell stack is 50 kg, and the material is assumed to be steel with a heat capacity of cp=0.45 kJ/kg·K. If this fuel cell stack is to be heated from a temperature of −15° C. to +5° C., it is necessary to supply 450 kJ of heat. This requires a heating power of at least 45 kW if the heating is to take place within less than 10 sec. If the fuel cell stack also contains 5 kg of coolant, such as for example a water/glycol mixture with a heat capacity of 3kJ/kg·K, the quantity of heat required rises to 750 kJ, and the heating power required rises to 75 kW. The heating power required rises accordingly at lower temperatures and if shorter starting times are to be achieved.

In practice, in the event of a cold start fuel cells are often heated indirectly by the flow of coolant which is heated with the aid of an electrical heating means and/or a fuel burner. This method has proven problematic in particular in terms of energy aspects, since the coolant, if only by dint of its quantity, has a high heat capacity and, moreover, losses occur as a result of the heat transfers which are required.

International patent application WO 00/54356 describes a method for cold-starting a fuel cell in which the heat of reaction from the combustion of the process gases is used to heat the fuel cell. The fuel cell which is designed for this method comprises a reaction chamber on each side of the centrally arranged electrolyte electrode assembly and lines for the processes gases of the fuel cell, which run in such a way that, when the fuel cell is being started, in each case both process gases can be introduced into the reaction chambers. The walls of the reaction chambers are covered with catalyst, so that the process gases are catalytically converted in the reaction chambers in the same way as in a catalytic burner.

In the method described in WO 00/54356, the heat is generated in the fuel cell itself, i.e. where it is required, so that losses resulting from heat transfers are avoided. Since in this case the fuel cell can also be heated without coolant, the mass which has to be heated and therefore also the heat capacity are relatively low. As a result, it is possible to achieve faster heat-up times. However, the cold start requires additional fuel even with the method described in WO 00/54356.

### SUMMARY OF THE INVENTION

The present invention proposes a possible way of improving the cold-starting performance of fuel cells of the type described in the introduction in which no additional fuel is consumed and which is therefore overall neutral in terms of energy.

The present invention provides a fuel cell having an electrolyte electrode assembly, on one side of which the cathode and on the other side of which the anode of the fuel cell are arranged, and having flow modules for the process gases and the coolant of the fuel cells arranged above these two electrodes. The flow module arranged above the anode and/or the flow module arranged above the cathode is/are formed at least in part from a material which is able to form a hydride, during which process heat is released. To cold-start a fuel cell which has been formed according to the present invention in this way, the flow module arranged above the anode and/or the flow module arranged above the cathode is/are flooded with a hydrogen-containing gas, so that hydride formation occurs. The fuel cell is heated by the heat which is released in the process.

This measure has proven particularly advantageous and simple if a corresponding flow module is arranged above the anode, since for the fuel cell to operate the anode must in any case be supplied with hydrogen. In this case, in the event of a cold start, therefore, no additional fuel is consumed. To this extent, the method according to the present invention is neutral in terms of energy, since the fuel cell waste heat, which would otherwise be unused, is utilized to regenerate the material of the flow module which is able to form a hydride. Moreover, it is particularly advantageous that in the method according to the present invention heat is generated directly where it is needed, namely in the fuel cell. In this way, there is no need for a heat-transfer medium, which also has to be heated, and heat transfers are as far as possible avoided.

Both in terms of manufacturing technology and with regard to production costs, it has proven advantageous if the process-gas passages of the anode-side flow module and/or cathode-side flow module are at least partly coated with the material which is able to form a hydride. Metals or metal alloys which are able to form low-temperature hydrides, such as for example titanium-iron alloys (TiFe) are particularly suitable for this purpose. Low-temperature hydrides are able to store hydrogen in a temperature range from −30° C. to +50° C. In this case, 360 kJ of thermal energy can be released per kg of metal hydride which is formed. Therefore, to generate 750 kJ of thermal energy, as required in the example described above, it is necessary for approx. 2.5 kg of metal hydride to be formed. A further advantage of using low-temperature hydrides consists in the fact that the hydrogen which is stored is released again under the normal operating conditions of the fuel cell, namely operating temperature T>70° C. and pressures of less than 10 bar.

In principle, the inventive measures which have been explained above for heating a fuel cell during a cold start can readily be combined with further heating measures, even if they are based on a different heating principle. A number of advantageous combinations are explained in more detail below as refinements of the present invention.

The internal heating according to the present invention resulting from exothermic hydride formation by a suitable material in the region of at least one flow module of the fuel cell can readily be combined with a further internal heating method, in which hydrogen is catalytically oxidized. The energy which is released in the process additionally heats the fuel cell. In this variant, at least one reaction space, into which, during the cold-starting phase, both a hydrogen-containing fluid and an oxygen-containing fluid can be introduced, is formed in at least one of the flow modules of the fuel cell. This reaction space also contains an oxidation catalyst for the exothermic conversion of the hydrogen, so that the reaction space acts as a catalytic burner. If the reaction space adjoins one of the electrodes of the fuel cell, the oxidation reaction can advantageously be catalyzed by an oxidation catalyst which has been applied to this electrode. In addition or as an alternative, it is also possible for a special oxidation catalyst, which should preferably be active at low temperatures, to be applied to the wall of the reaction space, i.e. the surface of the flow module. For example, the oxidation reaction can be catalyzed by an ultra-thin layer of platinum, which has been produced by PVD, CVD or electrodeposition on the surface of the flow module. A platinum layer of this type can at the same time be used to protect the flow module against corrosion or if appropriate also to ensure sufficient electrical conductivity.

The internal heating of the fuel cell according to the present invention as a result of exothermic hydride formation by a suitable material in the region of the flow modules can also be assisted by electrical heating of the flow modules, which form the main portion of the thermal mass of a fuel cell. In this context, it has proven advantageous for at least one heating element to be mechanically integrated in at least one of the flow modules.

Moreover, in the event of a cold start, it has also proven advantageous for the quantity of coolant passed through the fuel cell and therefore the total thermal mass of the fuel cell which has to be heated to be reduced and for the fuel cell to be operated with the minimum required quantity of coolant until the starting temperature is reached. As a result of the coolant passed through the fuel cell being heated, the fuel cell can be indirectly heated in addition to the internal heating according to the present invention. The coolant can simply be pumped out of the cooling circuit of the fuel cell, with the result that the thermal mass of the fuel cell can be reduced by almost 50%. In this case, a compensation vessel has to be provided in order to collect the coolant which has been pumped out, so that it can be fed back into the cooling circuit after the fuel cell starting temperature has been reached. However, the amount of coolant which has to be heated with the fuel cell can also be reduced by short-circuiting the cooling circuit. In any case, it is advantageous to reduce the quantity of coolant as a function of the ambient temperature. By way of example, the coolant can be heated electrically with the aid of an additional battery or by chemical energy with the aid of a fuel burner. To externally heat the coolant passed through the fuel cell, it is also possible to provide a heat exchanger which is formed at least in part from a material, preferably is coated with a material, which is able to form a hydride, with heat being released in the process. In the event of a cold start, the heat exchanger is flooded with a hydrogen-containing gas. The coolant inside the heat exchanger is heated by the hydride formation or the heat which is released in the process.

In practice, it is usual to use what are known as fuel cell stacks, i.e. fuel cell units which comprise a plurality of fuel cells connected to one another. Fuel cell stacks generally operate with energy efficiencies of 40-70%. The energy loss is in the form of thermal energy which is dissipated via the coolant. Assuming suitable control of the flow of coolant, a fuel cell stack is automatically heated from its starting temperature to its normal operating temperature by this energy loss.

In practice, it is quite acceptable if the maximum power of a fuel cell unit is not available immediately after a cold-start of this unit. Therefore, the present invention proposes a fuel cell unit of segmented structure, which comprises a starting unit having at least one fuel cell, as has been described above in accordance with the present invention, and at least one further unit having further fuel cells. According to the present invention, in the event of a cold start, the fuel cells of the starting unit should be activated first. Since the starting unit forms a smaller thermal mass than the fuel cell unit as a whole, the starting unit can be bought to the required starting temperature relatively quickly. The energy loss from the starting unit heats the coolant, which, at least after the starting temperature has been reached, is also passed through the further units of the fuel cell unit and heats them, so that they too are brought to the starting temperature.

As has already been explained extensively above, there are various possible ways of configuring and refining the teaching of the present invention in an advantageous way.

### BRIEF DESCRIPTION OF THE DRAWINGS

In this context, reference is made to the patent claims and to the following description of a plurality of exemplary embodiments of the present invention with reference to the drawings, in which:

FIG. 1 diagrammatically depicts a fuel cell cooling circuit with a short-circuiting option;

FIGS. 2a and 2b each diagrammatically depict a plan view of a flow module which is equipped with electrical heating elements; and

FIGS. 3a and 3b diagrammatically depict two possible connection options for the starting unit of a fuel cell unit.

### DETAILED DESCRIPTION

As has already been mentioned, in the event of a cold start, fuel cells first of all have to be heated to their starting temperature before they themselves are able to generate power. The lower the thermal mass of the fuel cell and coolant in the fuel cell which has to be heated, the lower the heating power which is required in order to reach the fuel cell starting temperature and the faster the fuel cell starting temperature is reached.

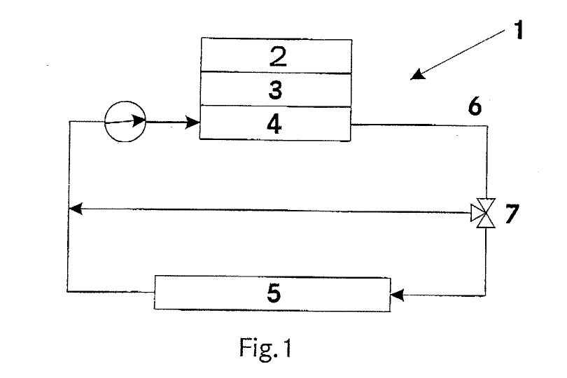

In addition to the inventive method of internal heating of a fuel cell by exothermic hydride formation by a suitable material arranged in the region of the flow module, it has proven advantageous for the thermal mass which is to be heated to be reduced during the cold-starting phase by short-circuiting the cooling circuit of the fuel cell. As illustrated in FIG. 1, in this case only a fraction of the quantity of coolant has to be heated together with the fuel cell 1. The individual components anode 2, cathode 3 and cooling 4 of the fuel cell I are only diagrammatically depicted in this figure. In this case, the cooling circuit 6 connected to a vehicle radiator 5 is short-circuited via a simple thermostatic valve 7.

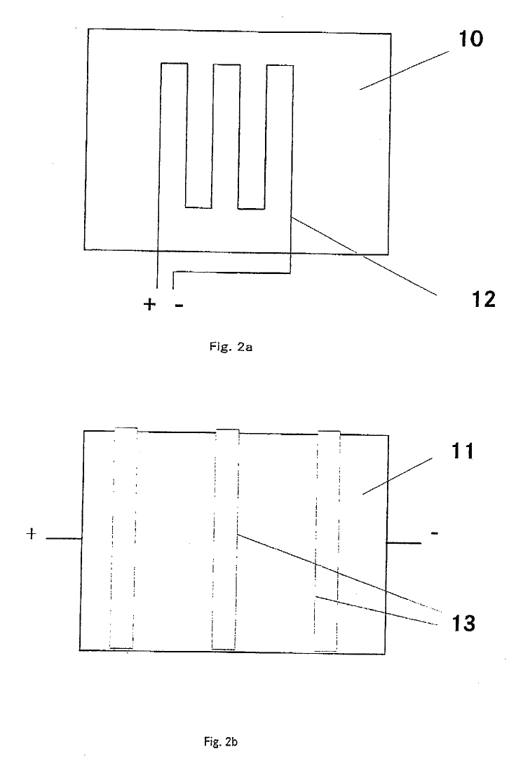

The structure of a fuel cell and accordingly also the structure of a fuel cell stack substantially comprises one or more MEAs (membrane electrode assemblies) and flow modules, which are generally produced in the form of bipolar plates and form a large proportion of the thermal mass of the structure. FIGS. 2a and 2b each illustrate a bipolar plate 10 and 11, in which electrical heating elements 12 and 13 for heating up the bipolar plate 10 and 11, respectively, and thereby the entire structure of the fuel cell or the fuel cell stack are integrated. In the case shown in FIG. 2a, an electrical heating conductor 12 with an external electrical insulation is mechanically integrated in the bipolar plate 10, which may consist, for example, of metal or graphite. In the case shown in FIG. 2b, regions 13 with an increased resistance are integrated in the bipolar plate 11 and serve as heating conductors.

As has already been mentioned, it is often sufficient if a fuel cell stack initially supplies a reduced power in the starting phase. Therefore, according to the present invention it is proposed for the fuel cell stack, depending on the minimum tolerable output, to be segmented into a starting unit and further units. If the fuel cell stack is segmented, for example, in a ⅓ ratio, the electrical power of the starting unit is only a quarter of the maximum power of the fuel cell stack. However, the mass of the starting unit is also only a quarter of the total fuel cell stack mass, so that for a given heating power the starting unit can be heated four times as quickly as the fuel cell stack as a whole, or to achieve the same starting time only a quarter of the heating power is required.

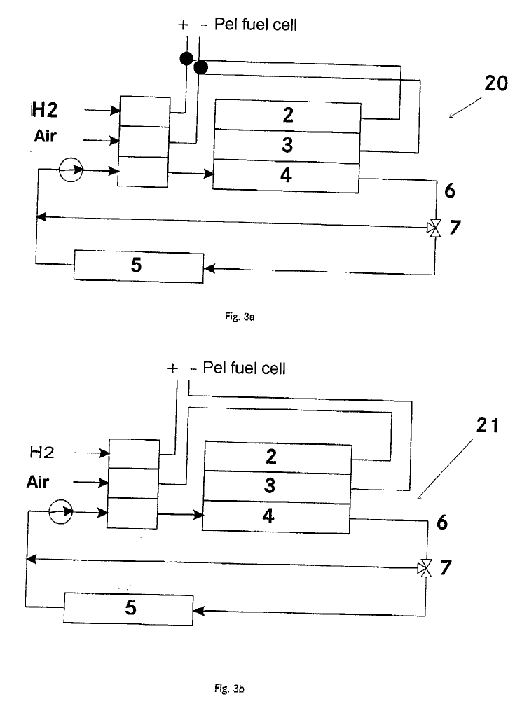

The variants illustrated in FIGS. 3a and 3b are recommended for the electrical configuration of a fuel cell stack of this type with starting unit and further units. In the case of series connection of starting unit 20 and a further unit, as illustrated in FIG. 3a, the direct current generated in the starting unit has to be converted in an AC converter and then transformed upwards to the desired voltage level. If starting unit 21 and a further unit are connected in parallel, as illustrated in FIG. 3b, they are designed in such a way that each unit provides the desired voltage.

The measures which have been explained above as part of the introduction of the description and the description of the figures—alone or in any desired combination—make it possible to significantly shorten the starting time of a fuel cell stack for a given heating power or to achieve a desired starting time with a relatively low heating power. As a result, with the aid of the fuel cell according to the present invention, particularly in the event of a cold start it is possible to save fuel, which is highly important in particular for automotive applications.

What is claimed is:

1. A fuel cell comprising:
an electrolyte electrode assembly including a cathode disposed on a first side and an anode disposed on a second side of the electrolyte electrode assembly;
a first flow module disposed adjacent the cathode; and
a second flow module disposed adjacent the anode, wherein at least one of the first and second flow modules includes a material suitable for exothermal hydride formation.

2. The fuel cell as recited in claim 1, wherein the first flow module is disposed above the cathode and is configured to carry a process gas and a coolant.

3. The fuel cell as recited in claim 1, wherein the second flow module is disposed above the anode and is configured to carry a process gases and a coolant.

4. The fuel cell as recited in claim 1, wherein first flow module includes first process-gas passages and the second flow module includes second process-gas passages, and wherein the material at least partly coats the first or second process-gas passages.

5. The fuel cell as recited in claim 1, wherein the material includes at least one of a metal and a metal alloy capable of forming low-temperature hydrides.

6. The fuel cell as recited in claim 1, wherein the material includes a titanium-iron alloy.

7. The fuel cell as recited in claim 1, wherein at least one of the first and second flow modules includes a reaction space for receiving a hydrogen-containing fluid and an oxygen-containing fluid, an oxidation catalyst for oxidizing hydrogen being disposed in the reaction space.

8. The fuel cell as recited in claim 7, wherein the oxidation catalyst is attached to one of the anode and the cathode.

9. The fuel cell as recited in claim 7, wherein the oxidation catalyst is attached to a surface of one of the first and second flow modules.

10. The fuel cell as recited in claim 7, wherein the oxidation catalyst is active at low temperatures.

11. The fuel cell as recited in claim 7, wherein the oxidation catalyst includes an ultra-thin platinum layer.

12. The fuel cell as recited in claim 1, wherein at least one of the first and second flow modules includes a heater element for electrically heating the flow module.

13. The fuel cell as recited in claim 1, further comprising a coolant restriction device configured to reduce a flow of a coolant through the fuel cell, and a heating device configured to externally heat the coolant.

14. The fuel cell as recited in claim 13, further comprising a cooling circuit, a compensation vessel, and a pump configured to pump coolant from the cooling circuit to the compensation vessel.

15. The fuel cell as recited in claim 14, wherein the cooling circuit includes for short-circuiting device for short-circuiting the cooling circuit.

16. The fuel cell as recited in claim 1, further comprising at least one of an electric heater and a fuel burner for externally heating a coolant of the fuel cell.

17. The fuel cell as recited in claim 1, further comprising a heat exchanger for externally heating a coolant of the fuel cell, wherein the heat exchanger includes a second material suitable for exothermic hydride formation and is configured to receive hydrogen so as to heat the coolant.

18. A fuel cell unit, comprising:
a starting unit having at least a first fuel cell including a cathode, a first flow module disposed adjacent the cathode, an anode, and a second flow module disposed adjacent the anode, at least one of the first and second flow modules including a material suitable for exothermal hydride formation,
a further unit connected to the starting unit and including at least a further fuel cell; and
a coolant communicating with the starting unit and the further unit, wherein the starting unit is configured to be activated before the further unit during a cold start so as to heat the further unit using the coolant.

19. The fuel cell unit as recited in claim 18, wherein the starting unit and the further unit are connected in series.

20. The fuel cell unit as recited in claim 18, wherein the starting unit and the further unit are connected in parallel.

21. A method for cold-starting a fuel cell, the fuel cell including a cathode, a first flow module disposed adjacent the cathode, an anode, and a second flow module disposed adjacent the anode, wherein at least one of the first and second flow modules includes a material suitable for an exothermal hydride formation, the method comprising:
flooding at least one of the first and second flow modules with a hydrogen-containing gas so as to induce the exothermic hydride formation and release heat; and
heating the fuel cell using the heat.

22. The method as recited in claim 21, wherein at least one of the first and second flow modules includes a reaction space, and the method further comprises introducing a first gas containing hydrogen and a second gas containing oxygen into the reaction space so as to catalytically oxidize the hydrogen.

23. The method as recited in claim 21, further comprising electrically heating at least one of the first and second flow modules.

24. The method as recited in claim 21, further comprising reducing a flow of a coolant through the fuel cell and externally heating the coolant.

25. The method as recited in claim 24, wherein reducing the flow includes reducing the flow as a function of an ambient temperature.

26. The method as recited in claim 21, further comprising pumping a coolant out of a cooling circuit of the fuel cell and collecting the coolant in a compensation vessel.

27. The method as recited in claim 21, further comprising short-circuiting a cooling circuit of the fuel cell.

28. The method as recited in claim 21, further comprising electrically heating a coolant passing through the fuel cell using a fuel burner.

29. The method as recited in claim 24, wherein the externally heating is performed using a heat exchanger including a second material suitable for exothermal hydride formation, and further comprising flooding the heat exchanger with a hydrogen-containing gas to induce hydride formation and to heat the coolant inside the heat exchanger.

30. The method as recited in claim 29, wherein the heat exchanger is coated with the second material.

31. A method for cold-starting a fuel cell unit, that includes a starting unit including a first fuel cell including a material suitable for exothermal hydride formation, a further unit including a further fuel cell, and a coolant communicating with the starting unit and the further unit, the method comprising:
activating the first fuel cell so as to bring the first fuel cell to a first fuel cell starting temperature;
heating the coolant;
bringing the further fuel cell to a further fuel cell starting temperature using the coolant.
